(19) United States
(12) Patent Application Publication
(10) Pub. No.: US 2026/0362059 A1
(43) Pub. Date: Nov. 12, 2026

(54) TRANSDUCER AND ASSOCIATED METHOD OF OPERATION

(71) Applicant: ADAMSON SYSTEMS ENGINEERING INC., Port Perry (CA)

(72) Inventors: Brian FRASER, Port Perry (CA); Brock ADAMSON, Port Perry (CA)

(21) Appl. No.: 19/125,899

(22) PCT Filed: Dec. 22, 2023
(86) PCT No.: PCT/CA2023/051747

§ 371 Date: Apr. 30, 2025

Related U.S. Application Data
(60) Provisional application No. 63/434,490, filed on Dec. 22, 2022.

(51) Int. Cl. H04R 7/16; H04R 1/02; H04R 1/22; H04R 1/28; H04R 1/30; H04R 7/12; H04R 9/02; H04R 9/04; H04R 9/06

(52) U.S. Cl. CPC H04R 7/16; H04R 1/025; H04R 1/227; H04R 1/2842; H04R 1/30; H04R 7/122; H04R 7/127; H04R 9/025; H04R 9/046; H04R 9/063; H04R 2307/027

(57) ABSTRACT

There is described a transducer. The transducer has: a static structure having a magnetic gap surrounding an axis, and a wall portion extending parallel to and facing the axis; a dynamic structure having a coil body surrounding the axis, a coil wrapped around the coil body, the coil body received in the magnetic gap, a diaphragm extending outwardly from the axis and secured to the coil body, the diaphragm having a peripheral edge adjacent the wall portion, the peripheral edge unattached to the wall portion; and a suspension connecting the static structure to the dynamic structure, the suspension limiting the movement freedom of the dynamic structure relative the static structure to axial movement along the axis, the suspension biasing the dynamic structure to a rest position, thereby delimiting a movement span xₘₐₓ defined axially, parallel the axis, between xₚₗᵤₛ and xₘᵢₙᵤₛ positions, the wall portion spanning the movement span xₘₐₓ.

### FIELD

The improvements relate to transducers and more particularly relate to audio drivers operable to convert electrical audio signals into sound waves.

### BACKGROUND

An audio driver is an electroacoustic transducer which, when driven with an electrical audio signal, typically carrying frequencies distributed in the audio frequency range ranging between 20 Hz and 20 kHz, radiates sound waves. The portion which interacts with the fluid carrying the sound waves, typically air, is referred to as a diaphragm. A coil of wire referred to as a voice coil is integral to the diaphragm and movably received in a magnetic gap. The magnetic gap typically has an annular configuration matching the diameter of the voice coil. Circulating the electrical audio signal in the voice coil generates an electromagnetic field which interacts with the magnetic field in the magnetic gap to drive the movement of the diaphragm. Minimizing the weight of the moving assembly, maximizing the stiffness of the diaphragm, and minimizing parasitic vibration modes can be key to achieving high-fidelity sound. In practice, an audio driver's design is typically optimized for operation in a specific portion of the audio frequency range with audio drivers designed for reproducing high audio frequencies commonly referred to as tweeters, those for middle frequencies commonly referred to as mid-range audio drivers, those for low frequencies commonly referred to as woofers, and those for the lowest audible frequencies commonly referred to as subwoofers. A plurality of audio drivers covering different portions of the audible frequency range are combined to form what is commonly referred to as a loudspeaker, although the expression loudspeaker can also be used to refer to a device having a single audio driver or to such a single audio driver. While existing audio drivers and loudspeaker designs were satisfactory to a certain degree, there always remains room for improvement.

### SUMMARY

To limit the weight of the dynamic structure, the diaphragm can be made of a relatively thin layer of material. However, to improve its stiffness, conical or spherical shapes can be used. In some embodiments, audio drivers can have two (or more) distinct suspensions which are responsible for i) confining the relative movement between the static structure and the dynamic structure to a displacement axis, and ii) biasing the dynamic structure to a rest position defined along the displacement axis, thereby limiting the movement of the dynamic structure to a movement span defined relative the displacement axis. In the field, it is common to refer to the displacement axis as the x-axis, and the movement span as the xₘₐₓ, i.e., the difference between a maximum positive movement position xₚₗᵤₛ, and a maximum negative movement position xₘᵢₙᵤₛ, from the rest position x_{zero}.

In one embodiment, a first suspension connects the voice coil to the frame, commonly referred to as a “spider,” and a second suspension connects the diaphragm to the frame, referred to as a “surround.” While the spider can be used to support the bulk of the weight of the diaphragm and voice coil, the surround can prevent the peripheral edge of the diaphragm from rocking from side to side and/or impede undesired vibration modes such as artifact modes and disturbances that may otherwise occur at the peripheral portion of the diaphragm. Moreover, sound waves of opposite phases are radiated by each face of the diaphragm during use. For instance, an in-phase sound wave is directed towards a listener while an out-of-phase sound wave is directed in an opposite direction where the driver or loudspeaker structure can be configured to damp it to a certain extent, although a portion of the out-of-phase sound wave can be reflected and generate a source of distortion. In addition to rocking protection, the surround can impede such an out-of-phase sound wave from interfering with the in-phase sound wave.

However, notwithstanding its great usefulness and widespread use, it was found that the surround also had inconveniences. For instance, the axial movement of the diaphragm is dampened by its attachment to the surround. More specifically, the diaphragm's movement causes the surround to deform repeatedly, thus creating equal opposing forces acting on a peripheral portion of the diaphragm. Such forces can translate into small but non-negligible mechanical deformations at the level of the peripheral portion that would not otherwise occur in a first order piston response. These deformations, in addition to the deformations of the surround itself, can interfere with a wavefront of the in-phase sound waves, thereby leading to undesirable higher order modal behaviour. Moreover, the presence of a surround in an audio driver provides additional bulkiness, such as depicted in the loudspeaker arrangement 2 of FIG. 1, in which the surround 4 attaches the diaphragm 8 to an outer frame 6 of the audio driver. As the diameter of the diaphragm is denoted by diameter D1, it was found that the diaphragm could reach up to diameter D2 without the presence of the surround. In this way, to obtain a similarly sized audio driver, the size of the diaphragm can be increased to generate even lower frequencies with fewer higher order modes. Alternately, while maintaining a similarly sized diaphragm, the size of the audio driver can be reduced thereby allowing for more compact loudspeaker arrangement. For instance, the spacings S1 and S2 shown in FIG. 1 could both be reduced if the surround were to be omitted. Such spacings can be particularly undesired in a linear array of identical audio drivers where sound quality can be correlated inversely to the distance between individual ones of the audio drivers.

Accordingly, it was found that the use of such a surround can be omitted when the construction of the audio driver is modified to address at least some of the former functions of the surround. There is described herein a transducer, e.g., an audio driver, in which a peripheral edge of the diaphragm is unattached to a wall portion of the frame, the wall portion extending parallel to the displacement axis and facing the displacement axis. As such, the peripheral edge axially oscillates in a frictionless and contactless manner adjacent the wall portion of the frame. It was found that when a clearance between the peripheral edge and the wall portion is sufficiently small, satisfactory artifact mode dampening and out-of-phase sound wave blocking can still be achieved. The frictionless and contactless pistonic motion of the peripheral edge can be ensured by making sure the peripheral edge stays clear of the wall portion the whole reciprocal movement of the diaphragm. This can be achieved by holding the dynamic structure in position within sufficiently tight tolerances by the suspension, and also making the diaphragm in a sufficiently stiff material. In this way, the suspension can delimit a movement span xₘₐₓ of the peripheral edge, with the movement span xₘₐₓ being defined axially, parallel the displacement axis, between an xₚₗᵤₛ position and an xₘᵢₙᵤₛ position. The wall portion is such that it spans the movement span xₘₐₓ of the peripheral edge during the axial movement of the diaphragm. By doing so, the peripheral edge of the diaphragm axially moves in a reciprocal manner within the movement span xₘₐₓ, the peripheral edge remaining adjacent to, surrounded by, and unattached to the wall portion throughout the movement span xₘₐₓ. As such, the transducer and audio driver described herein can have a reduced footprint compared to existing transducers and audio drivers having a similarly sized diaphragm. Such improvements can also lead to more compact audio driver arrays.

In accordance with a first aspect of the present disclosure, there is provided a transducer comprising: a static structure having a magnetic gap surrounding a displacement axis, and a wall portion extending parallel to the displacement axis, facing the displacement axis; a dynamic structure having a coil body surrounding the displacement axis, a coil wrapped around the coil body, the coil body received in the magnetic gap, a diaphragm extending outwardly from the displacement axis and secured to the coil body, the diaphragm having a peripheral edge adjacent the wall portion, the peripheral edge unattached to the wall portion; and a suspension connecting the static structure to the dynamic structure, the suspension limiting a freedom of movement of the dynamic structure relative the static structure to axial movement along the displacement axis, the suspension biasing the dynamic structure to a rest position, thereby delimiting a movement span xₘₐₓ of the peripheral edge, the movement span xₘₐₓ defined axially, parallel the displacement axis, between an xₚₗᵤₛ position and an xₘᵢₙᵤₛ position, the wall portion spanning the movement span xₘₐₓ of the peripheral edge.

Further in accordance with the first aspect of the present disclosure, the diaphragm can for example have a peripheral portion protruding from the coil body in a direction away from the displacement axis, the peripheral edge being a free peripheral edge.

Still further in accordance with the first aspect of the present disclosure, the diaphragm can for example have a spherical cap concentric the displacement axis, the peripheral portion can for example extend around the spherical cap, the spherical cap can for example have a concave face opposite a convex face, one of the convex face and the concave face can for example face away from the static structure.

Still further in accordance with the first aspect of the present disclosure, the peripheral portion can for example have a truncated conical shape surrounding the displacement axis, the truncated conical shape can for example be sloped obliquely relative the displacement axis.

Still further in accordance with the first aspect of the present disclosure, the peripheral portion can for example be part of the spherical cap.

Still further in accordance with the first aspect of the present disclosure, the diaphragm can for example have a central portion surrounded by the peripheral portion, the central portion can for example span a first cross-sectional area, defined relative the displacement axis, the peripheral portion can for example span a second cross-sectional area, the first cross-sectional area greater than the second cross-sectional area.

Still further in accordance with the first aspect of the present disclosure, the wall portion can for example circumscribe a first cross-sectional area defined relative the displacement axis, and the diaphragm can for example span a second cross-sectional area, the second cross-sectional area covering at least 95% of the first cross-sectional area, preferably at least 97%.

Still further in accordance with the first aspect of the present disclosure, the suspension can for example have a first suspension member extending radially outwardly between the coil body and the static structure relative the displacement axis.

Still further in accordance with the first aspect of the present disclosure, the wall portion can for example be cylindrical and the peripheral edge is circular.

Still further in accordance with the first aspect of the present disclosure, the transducer can for example have a clearance defined radially between the peripheral edge and the wall portion, the clearance being less than 500 μm.

Still further in accordance with the first aspect of the present disclosure, the static structure can for example have an annular resonant cavity opened at a clearance defined radially between the peripheral edge and the wall portion, the annular resonant cavity can for example have a Helmholtz frequency tuned above a passband of the transducer.

Still further in accordance with the first aspect of the present disclosure, the diaphragm can for example be made of a composite material.

Still further in accordance with the first aspect of the present disclosure, the diaphragm can for example be made of titanium.

Still further in accordance with the first aspect of the present disclosure, the diaphragm can for example be made of a plastic, preferably polyether ether ketone (PEEK).

Still further in accordance with the first aspect of the present disclosure, the transducer can for example have a horn loaded on the transducer, the diaphragm can for example remain harmonics-free when operated under additional pressure exerted by the horn.

Still further in accordance with the first aspect of the present disclosure, an audio driver array which can for example have a plurality of transducers mounted to one another, the transducers of the plurality corresponding to the transducer according to the first aspect of the present disclosure.

Still further in accordance with the first aspect of the present disclosure, the audio driver array can for example have an array frame having a plurality of spaced-apart transducer apertures, the plurality of transducers mounted to corresponding ones of the plurality of transducer apertures.

Still further in accordance with the first aspect of the present disclosure, the array frame can for example be a housing having a wall and a cavity inside the housing, the wall including the plurality of transducer apertures which expose the cavity.

Still further in accordance with the first aspect of the present disclosure, diaphragms of the plurality of transducers can for example collectively form a radiating surface area, the radiating surface area can for example encompass at least 65% of a surface area of the wall, preferably at least 70% of the surface area of the wall and most preferably at least 75% of the surface area of the wall.

In accordance with a second aspect of the present disclosure, there is provided a method of driving an audio driver, the method comprising: circulating an audio signal in the form of an electrical current along a coil wrapped around an annular body, thereby generating an electromagnetic field, the annular body bearing a diaphragm; the electromagnetic field engaging a magnetic field in a magnetic gap, thereby moving the diaphragm reciprocally relative the magnetic gap along a displacement axis, said moving the diaphragm including moving a peripheral edge of the diaphragm reciprocally within a movement span, the peripheral edge remaining adjacent to, surrounded by, and unattached to a wall portion throughout said movement span.

In accordance with a third aspect of the present disclosure, there is provided an audio driver comprising: a static structure having: a magnet assembly having a magnetic gap surrounding a displacement axis, the magnetic gap at a first location along the displacement axis, and a frame having a wall portion facing the displacement axis, the wall portion at a second location along the displacement axis, the second location offset from the first location along the displacement axis; a dynamic structure having: a voice coil having a body surrounding the displacement axis, the body having a first end axially opposite a second end relative the displacement axis, and a coil wrapped around the body, the coil received in the magnetic gap, and a diaphragm secured to the first end of the body, the diaphragm extending transversally to the displacement axis and having a peripheral portion protruding from the body in a direction away from the displacement axis, the peripheral portion having a free peripheral edge adjacent the wall portion, the free peripheral edge unattached to the wall portion; and a suspension connecting the static structure to the voice coil, the suspension extending radially between the voice coil and the static structure relative to the displacement axis, limiting the movement of the voice coil to an orientation of the displacement axis, and biasing the voice coil to a rest position.

In accordance with a fourth aspect of the present disclosure, there is provided a method of driving an audio driver, the audio driver having a displacement axis, a static structure surrounding the displacement axis, the static structure having a wall portion facing the displacement axis, a dynamic structure surrounding the displacement axis, the dynamic structure having a diaphragm extending transversally to the displacement axis, the diaphragm having an edge adjacent the wall portion, and a suspension connecting the static structure and the dynamic structure to one another, the method comprising: driving movement of the diaphragm in a reciprocating motion along the displacement axis while maintaining the edge of the diaphragm unattached to the wall portion, said moving including the edge axially oscillating in a frictionless manner adjacent the wall portion.

In accordance with a fifth aspect of the present disclosure, there is provided a transducer comprising: a static structure having a magnetic gap surrounding a displacement axis, and a wall portion facing the displacement axis, the wall portion offset from the magnetic gap along the displacement axis; a dynamic structure having a coil body surrounding the displacement axis, a coil wrapped around the coil body, the coil received in the magnetic gap, a diaphragm secured to the coil body, the diaphragm extending transversally to the displacement axis, the diaphragm having an edge adjacent the wall portion, the edge unattached to the wall portion; and a suspension connecting the static structure to the coil body.

Many further features and combinations thereof concerning the present improvements will appear to those skilled in the art following a reading of the instant disclosure.

### DESCRIPTION OF THE FIGURES

In the figures,

FIG. 1 is a partial, top plan view of an example of a loudspeaker having a vertical array of audio drivers with surrounds, in accordance with the prior art;

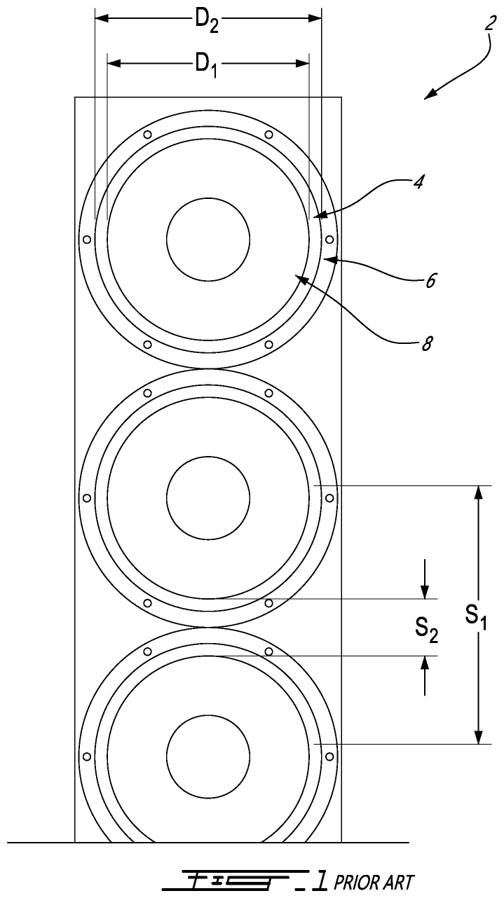

FIG. 2 is an exploded view of an example of an audio driver, in accordance with one or more embodiments;

FIG. 2A is an oblique view of the audio driver of FIG. 2, in accordance with one or more embodiments;

FIG. 2B is a sectional view of the audio driver of FIG. 2A, taken along section 2B-2B of FIG. 2, in accordance with one or more embodiments;

FIG. 3 is an enlarged view of the audio driver of FIG. 2A, in accordance with one or more embodiments;

FIG. 4 is an enlarged view of another example of an audio driver, shown with an air seal, in accordance with one or more embodiments;

FIG. 5 is an audio driver array, shown with a column housing having four audio drivers embedded therein, in accordance with one or more embodiments;

FIGS. 6A, 6B and 6C are sectional views of different examples of transducers, shown with a convex diaphragm, a concave diaphragm and a planar diaphragm, respectively, in accordance with one or more embodiments;

FIG. 6 is a sectional view of an example of an audio driver, shown with a horn loaded on the audio driver, in accordance with one or more embodiments; and

FIG. 7 is a sectional view of another example of a transducer, in accordance with one or more embodiments.

### DETAILED DESCRIPTION

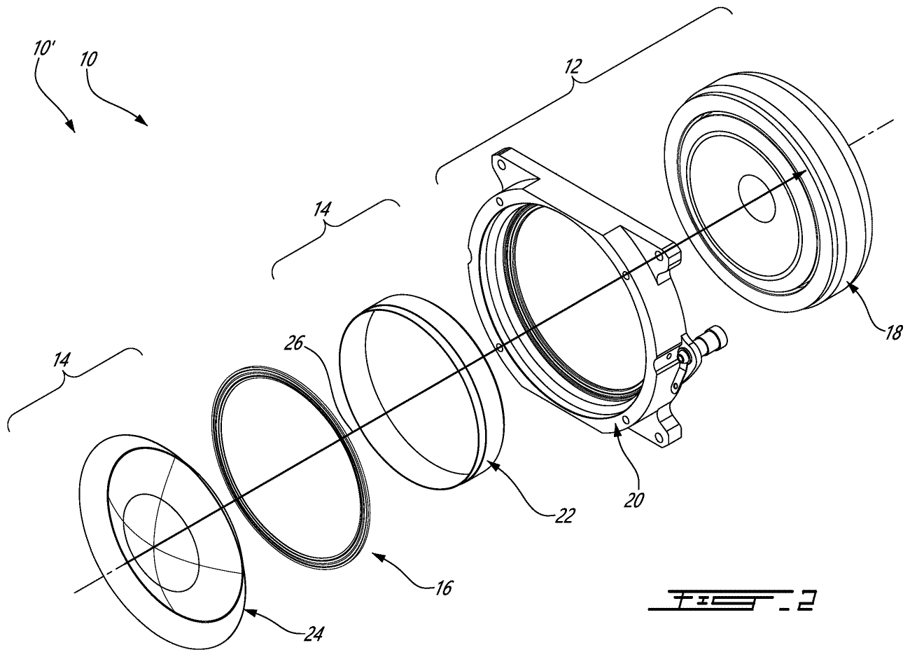

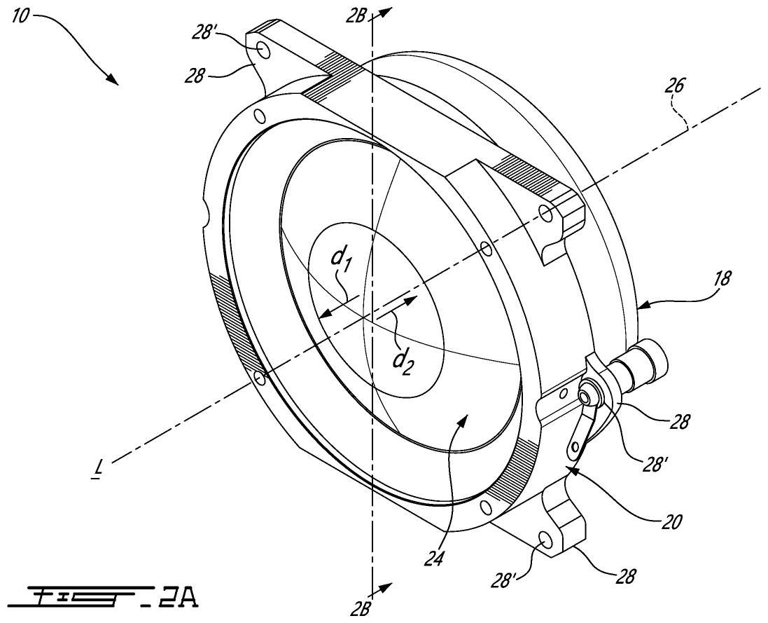

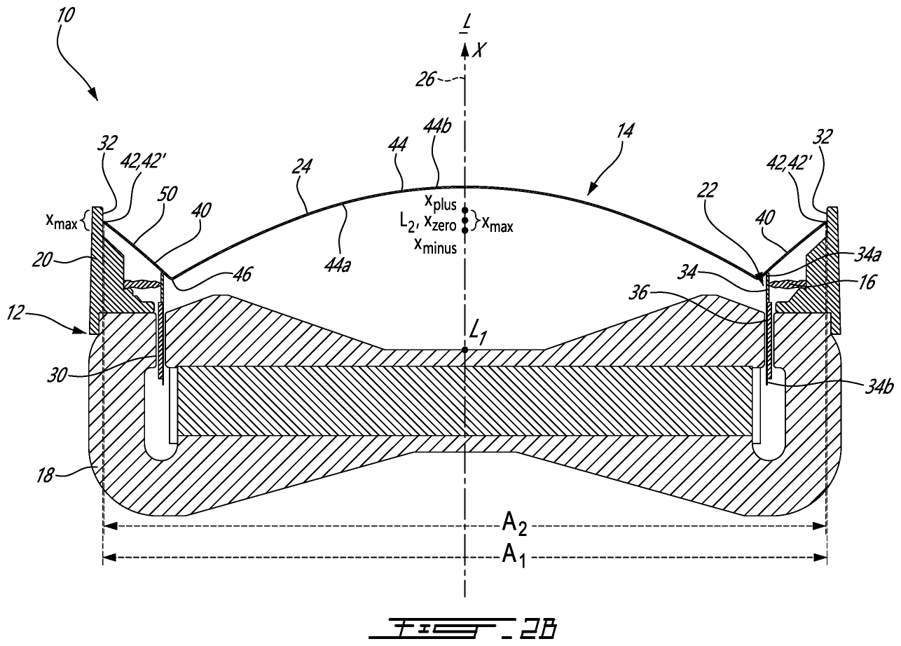

FIG. 2 shows an exploded view of an example of a transducer 10′. In this embodiment, the transducer 10′ is provided in the form of an audio driver 10. The audio driver 10 can be sized, shaped and driven to produce low-range frequencies, mid-range frequencies or high-range frequencies, depending on the embodiment. The audio driver 10 can be part of a tweeter system, a mid-range audio driver system, a woofer system, a subwoofer system, or any other type of loudspeaker system.

As depicted, the audio driver 10 has a static structure 12, a dynamic structure 14 and a suspension 16. In this example, the static structure 12 has a magnet assembly 18 and a frame 20, and the dynamic structure 14 has a voice coil 22 and a diaphragm 24. As illustrated, these components are axisymmetric and concentric relative to a displacement axis 26.

FIG. 2A shows an oblique view of the audio driver 10 when assembled. As shown, when the audio driver 10 is driven with an electrical audio signal, in-phase sound waves are generated in a first direction d1 extending along the displacement axis 26 while out-of-phase sound waves are generated in an opposite, second direction d2 extending along the displacement axis 26. The in-phase sound waves generally have a 180-degree phase difference relative to the out-of-phase sound waves. The in-phase sound waves are generally directed to a listener L facing the diaphragm 24 of the audio driver 10. However, other components of the audio driver 10 including, but not limited to, the frame 20, the magnet assembly 18, connectors, caps and vents can be found behind the diaphragm 24. As shown in this embodiment, the frame 20 is provided with attachment elements 28 circumferentially distributed around the frame 20 and radially outwardly therefrom. In this embodiment, the attachment elements 28 have through holes 28′ with which the frame 20 can be removably affixed to a surface, e.g., a surface of a loudspeaker system, using fasteners, for instance.

Reference is now made to FIG. 2B, which shows a sectional view of the audio driver 10. As shown, the static structure 12 has a magnetic gap 30 which surrounds a displacement axis 26, and a wall portion 32 which extends parallel to the displacement axis 26 and which faces the displacement axis 26. In this specific example, the magnetic gap 30 is part of the magnet assembly 18 and the wall portion 32 is part of the frame 20. As shown, the magnetic gap 30 is located at a first location L1 along the displacement axis 26. The wall portion 32 is located at a second location L2 along the displacement axis, with the second location L2 being axially offset from the first location L1 along the displacement axis 26.

As depicted, the dynamic structure 14 has a coil body 34 (or “body 34”) surrounding the displacement axis 26. The body 34 has a first end 34a axially opposite a second end 34b relative the displacement axis 26. The dynamic structure 14 is also provided with a coil 36 wrapped around the body 34 and received in the magnetic gap 30 of the magnetic assembly 18. The coil body 34 and the coil 36 form the voice coil 22 in this embodiment. The diaphragm 24 is secured to the coil body 34, and more specifically in this embodiment, to the first end 34a of the body 34. As shown, the diaphragm 24 extends outwardly from the displacement axis 26. The diaphragm 24 has a peripheral edge 42 adjacent the wall portion 32. The peripheral edge 42 is unattached to the wall portion 32. In this specific embodiment, the diaphragm 24 has a peripheral portion 40 protruding from the body 34 in a direction away from the displacement axis 26, and the peripheral edge 42 is a free peripheral edge 42′ of the peripheral portion 40. Typically, the diaphragm 24 is axisymmetric, and all the moving parts are coaxially and concentrically disposed relative to the displacement axis 26.

The suspension 16 connects the static structure 12 to the dynamic structure 14. More specifically, in this embodiment, the suspension 16 extends radially outwardly between the coil body 34 and the static structure 12 relative the displacement axis 26. The suspension 16 thus connects the static structure 12, e.g., the frame 20, to the voice coil 22. In this embodiment, the suspension 16 extends radially between the voice coil 22 and the static structure 12 relative to the displacement axis 26. As such, the suspension 16 limits the movement of the voice coil 22 to an orientation of the displacement axis 26, and biases the voice coil 22 to a rest position. More specifically, the suspension 16 limits a freedom of movement of the dynamic structure 14 relative the static structure 12 to axial movement along the displacement axis 26. The suspension 16 biases the dynamic structure 14 to a rest position, thereby delimiting a movement span xₘₐₓ of the peripheral edge 42, the movement span xₘₐₓ is defined axially, parallel the displacement axis 26, and extends between an xₚₗᵤₛ position and an xₘᵢₙᵤₛ position. As such, the wall portion 32 spans the movement span xₘₐₓ of the peripheral edge 42.

It is intended that driving of the audio driver 10 includes a step of driving movement of the diaphragm 24 in a reciprocating motion along the displacement axis 26 while maintaining the peripheral edge 42 of the diaphragm 24 unattached to the wall portion 32. As such, during driving of the audio driver 10, the peripheral edge 42 axially oscillates in a frictionless, contactless and pistonic manner adjacent the wall portion 32. During the pistonic motion of the diaphragm 24, the peripheral edge 42 of the diaphragm 24 moves reciprocally within the movement span xₘₐₓ, with the peripheral edge 42 remaining adjacent to, surrounded by, and unattached to the wall portion 32 throughout the movement span xₘₐₓ.

The audio driver 10 can be driven with an electrical audio signal by circulating the electrical audio signal into the coil 36 of the voice coil 22. By doing so, the circulating current creates a magnetic field around the coil 36, with some magnetic field lines directed axially along the displacement axis 26 within the coil 36. As the electrical audio signal is an alternating current (AC) signal, the polarity of the electrical audio signal alternates over time. When the polarity is positive, the magnetic field lines are directed towards a first direction along the displacement axis 26, which causes the magnetic assembly to axially repel (or attract) the energized coil 36. When the polarity becomes negative, then the magnetic field lines switch direction towards an opposite, second direction along the displacement axis 26, which causes the magnetic assembly to axially attract (or repel) the energized coil 36. Magnetic interaction between the magnet assembly 18 and these direction-changing magnetic lines cause the dynamic structure 14 to be moved in an axial reciprocating motion when driven with the AC signal. As such, during the driving of the audio driver 10, the suspension 16 limits the movement of the voice coil 22 to the orientation of the displacement axis 26 which prevents situations where the voice coil 22 would contact inside walls of the magnetic gap 30. Preferably, the suspension 16 ensures that the coil 36 is received in a frictionless and contactless manner within the magnetic gap 30. When the driving is interrupted, the suspension 16 biases the voice coil 22 back to the rest position.

As shown, the wall portion 32 circumscribes a first cross-sectional area A1 defined transversally relative the displacement axis 26. Similarly, the diaphragm spans a second cross-sectional area A2 transversally relative the displacement axis 26. In some embodiments, the second cross-sectional area A2 encompasses at least 95%, preferably 97% and most preferably at least 99% of the first cross-sectional area A1. Thus, for similarly sized diaphragm, the audio driver 10 can have a substantially smaller footprint than that of the audio drivers having surrounds. Alternately or additionally, for audio drivers of similar footprints, the audio driver 10 can radiate sound waves at lower frequencies than the audio driver having surrounds can, due to the presence of the surround and necessarily smaller diaphragm.

In some embodiments, the diaphragm 24 has a central portion provided in the form of a spherical cap 44 which is positioned concentrically to the displacement axis 26. In this way, the peripheral portion 40 extends around the spherical cap 44. In some embodiments, the spherical cap 44 and the peripheral portion 40 can be molded or otherwise provided in a monolithic unit. However, in some other embodiments, the spherical cap 44 and the peripheral portion 40 may be separate parts that are permanently or removably mounted to one another. As shown in this embodiment, the diaphragm 24 has a bent portion 46 extending between the spherical cap 44 and the peripheral portion 40. Although the bent portion 46 is shown to within the body 34 of the voice coil 22, the bent portion 46 delimiting the spherical cap 44 from the peripheral portion 40 can be positioned radially outside or contiguous to the voice coil 22 in some other embodiments. As shown, the spherical cap 44 has a concave face 44a opposite a convex face 44b. In this illustrated example, the convex face 44b faces the listener L, away from the static structure 12. However, in some other embodiments, the spherical cap 44 can be upside down with the concave face 44a facing the listener L, away from the static structure 12.

In some embodiments, the peripheral portion 40 of the diaphragm 24 can be provided in the form of a truncated conical shape 50 being annularly disposed around the displacement axis 26 and surrounding the spherical cap 44. The truncated conical shape 50 is sloped obliquely relative the displacement axis 26. The truncated conical shape 50 can taper in both directions of the displacement axis 26. For instance, such as shown in FIG. 2B, the truncated conical shape 50 tapers towards the static structure 12 and thereby present an inverted truncated conical shape. Depending on the embodiment, the spherical cap 44 can have a surface area which is greater, equal to or smaller than a surface area of the truncated conical shape 50 of the peripheral portion 40. However, it was found preferable to oversize the spherical cap 44 relative to the truncated conical shape 50 such as shown in the illustrated embodiment. In other words, the spherical cap 44 can have a surface area which is greater than a surface area of the truncated conical shape 50. The surface area of the spherical cap can be 45%, preferably 55% and most preferably 60% greater than the surface area of the truncated conical shape 50. In these embodiments, the larger surface area of the spherical cap 44 can provide enhanced structure and stiffness to the overall diaphragm 24, which can conveniently help maintain a frictionless motion between the peripheral edge 42 and the wall portion 32. As such, the small portion of the truncated conical shape 50 extending outside the voice coil 22 is shaped such that there is no modal activity in the operating bandwidth of the audio driver 10 and there is no surround to interfere with the diaphragm's balance. Thus, cone rocking, a side-to-side non-axial movement of the diaphragm 24, can be eliminated.

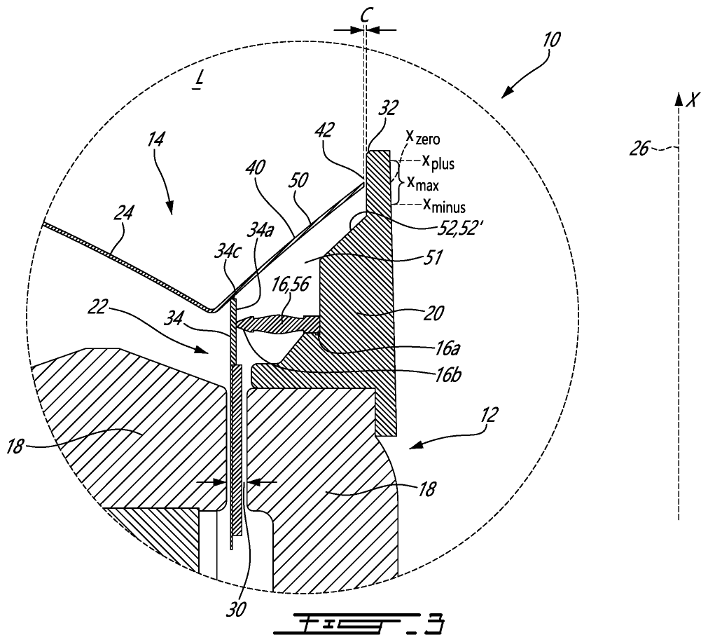

Referring now to FIG. 3, the audio driver 10 is shown with a clearance C extending between the peripheral edge 42 and the wall portion 32. In some embodiments, the clearance C is less than 500 μm, preferably less than 400 μm, and most preferably less than 250 μm. In some embodiments, the clearance C is such that it prevents an airflow from circulating between the peripheral edge 42 and the wall portion 32. Considering that the wall portion 32 is cylindrical and the diaphragm 24 is circular in this embodiment, the clearance C extends annularly around the displacement axis. As such, the annular clearance C can prevent an out-of-phase sound wave from interfering with the in-phase sound wave should the out-of-phase sound wave be reflected within the audio driver 10. Moreover, the annular clearance C can also dampen artifact modes and disturbances that may occur at the free peripheral portion edge 42 of the diaphragm 24 adjacent the wall portion 32. Such artifact modes and disturbances created at the annular clearance C can be less significant than what would be created at the surround of an existing audio driver. The diaphragm 24 is made of a stiff material. For instance, the diaphragm 24 can be made of a composite material, titanium, graphite, stiff plastic such as polyether ether ketone (PEEK), or a combination thereof. In these embodiments, the stiffness of the diaphragm 24 can prevent it from rocking from side to side during driving of the audio driver 10. Moreover, lightness and stiffness of the diaphragm material can favor a first order piston response for a substantially portion of the audio driver's bandwidth. However, in some embodiments, higher order modal behaviour in an upper portion of the audio driver's bandwidth can be acceptable, due to structural and material limitations. Many high strength, high stiffness materials may be used to produce a lightweight rigid diaphragm 24 and frame 20.

In some embodiments, the peripheral edge 42 and the wall portion 32 have circular geometries that are concentric to one another relative to the displacement axis. In this way, the air circulation which may occur across the annular clearance C can be constant all around the displacement axis, which can further impede mode artifacts and disturbances which could otherwise occur at the annular clearance C.

In some embodiments, the audio driver 10 has an annular resonant cavity 51 circumscribed by the wall portion 32, the suspension 16, the body 34 and the peripheral portion 40. The cavity 51 is exposed and opened at the annular clearance C which extends between the peripheral edge 42 and the wall portion 32. In these embodiments, the annular resonant cavity 51 has a Helmholtz frequency tuned away from a passband of the audio driver 10 by appropriate selection of parameters such as the size and geometry of the cavity 51. For instance, the Helmholtz frequency can be tuned above the passband of the audio driver 10 in some embodiments whereas in some other embodiments the Helmholtz frequency can be tuned below the passband of the audio driver 10. As such, the out-of-phase sound waves generated by the diaphragm and propagated within the annular resonant cavity 51 may not excite the Helmholtz resonance mode of the annular resonant cavity 51. This can be preferred because in embodiments where the Helmholtz frequency is within the audio frequencies of the audio driver, energy from the sound waves may excite the Helmholtz resonance, which may adversely affect the performance of the audio driver 10. In some embodiments, the annular resonant cavity 51 is configured for discarding or absorbing the out-of-phase sound waves by absorption. In some other embodiments, the out-of-phase sound waves produced within the annular resonant cavity 51 by the diaphragm 24 can be reflected and phase shifted so as to constructively interfere with the in-phase sound waves for reinforcement towards the listener L.

As shown in this embodiment, the wall portion 32 is preferably cylindrical around the displacement axis, although the wall portion 32 needs not to be perfectly cylindrical. Such a cylindrical shape for the wall portion 32 helps maintain the airflow circulating across the annular clearance C constant regardless of the position of the diaphragm 24 during the reciprocating motion cycle. In other words, the airflow circulating across the annular clearance C is relatively similar when the diaphragm 24 is at both axial maximal positions, i.e., the position closest to the static structure 12 and the position farthest from the static structure 12.

In some embodiments, the frame 20 has a collar portion 52 extending between the wall portion 32 and a static edge 16a of the suspension 16. Preferably, the peripheral portion 40 of the diaphragm 24 clears the collar portion 52 during its axial reciprocating motion. In these embodiments, the shape of the collar portion 52 is defined by a mating or otherwise corresponding shape of the peripheral portion 40 of the diaphragm 24. For instance, in the illustrated embodiment, the collar portion 52 has a slanted shape 52′ extending obliquely relative to the wall portion 32. This slanted shape 52′ is sized and shaped so as to remain clear of the truncated conical shape 50 of the peripheral portion 40 during the reciprocating motion of the diaphragm 24.

As shown in this example, the suspension 16 can be provided in the form of a spider 56. As such, the suspension 16 can provide structural support for the mass of the dynamic structure 14, rigid lateral alignment of the voice coil 22 within the magnetic gap 30, and sufficient axial movement for the diaphragm 24. Depending on the embodiment, the suspension 16 can extend radially and/or axially. Moreover, the suspension 16 can extend inwardly from the coil body towards a pole piece of the magnet assembly, and or extend outwardly from the coil body towards the frame. In this embodiment, the suspension 16 has the static edge 16a connected to an internal face of the frame 20. However, in some other embodiments, the static edge 16a of the suspension 16 may be connected to an internal face of the magnet assembly 18. Moreover, the suspension 16 has a dynamic edge 16b connected to the body 34 of the voice coil 22. As shown, the dynamic edge 16b of the suspension 16 is connected to the first end 34a of the body 34. It is understood that the dynamic edge 16b of the suspension 16 needs not to be connected at a rim portion 34c of the body 34, but anywhere adjacent the first end 34a of the body 34, such as shown in FIG. 3.

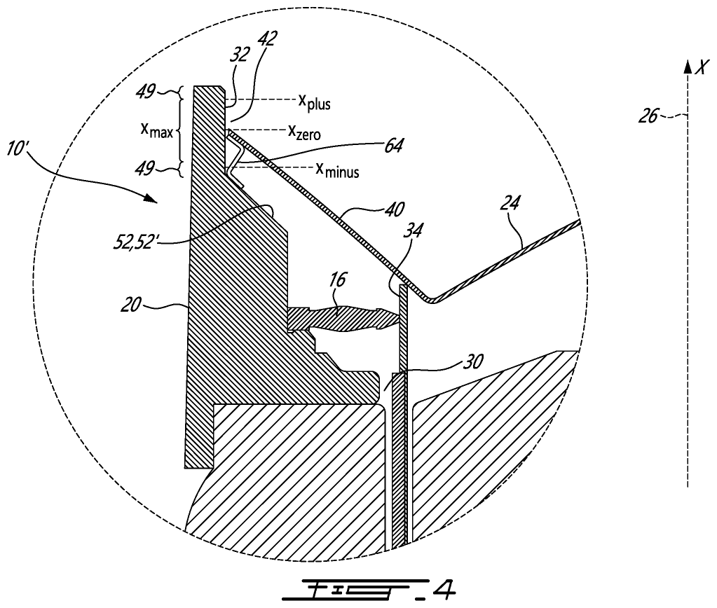

FIG. 4 shows an enlarged view of another example of a transducer 10′. As shown, the suspension 16 connects an exterior face of the coil body 34 to the frame 20, thereby delimiting a movement span xₘₐₓ of the peripheral edge 42. More specifically, the movement span xₘₐₓ is defined axially, parallel the displacement axis 26, and extends between an xₚₗᵤₛ position and xₘᵢₙᵤₛ position. In this example, the displacement axis 26 is referred to as the x-axis, and the movement span of the peripheral edge 42 of the diaphragm 24 is denoted xₘₐₓ. The movement span xₘₐₓ is defined as the difference between a maximum positive movement position xₚₗᵤₛ, and a maximum negative movement position xₘᵢₙᵤₛ, from the rest position x_{zero}, xₘₐₓ=xₚₗᵤₛ−xₘᵢₙᵤₛ. As such, the wall portion 32 spans the movement span xₘₐₓ of the peripheral edge 42 during its pistonic reciprocal axial motion. As shown, it is understood that the frame 20 can axially exceed the wall portion 32. For instance, and as illustrated, the frame 20 can have an exceeding wall portion 49 above and/or below the wall portion 32. The exceeding wall portions 49 can share the same shape as the wall portion 32. However, the exceeding wall portions 49 may not encompass the movement span xₘₐₓ of the diaphragm 24. In some other embodiments, the exceeding wall portions 49 can have shapes different from a shape of wall portion 32. As shown in this embodiment, the frame 20 has a collar portion 52 of a slanted shape 52′ extending obliquely relative to the wall portion 32. As shown, the slanted shape 52′ is offset relative to the movement span xₘₐₓ, and is well below the maximum negative movement position xₘᵢₙᵤₛ. In some embodiments, the transducer 10′ is provided with an air seal 64 connecting the peripheral portion 40 to the slanted shape 52′ of the frame 20. As shown, the air seal can be connected to the peripheral edge 42 of the diaphragm. The air seal 68 can be made of an elastic foam, for instance, to prevent dirt to reaching the magnetic gap 30.

In some embodiments, there is provided an audio driver array. In these embodiments, the audio driver array includes a number of audio drivers mounted directly or indirectly to one another. In some embodiments, each of the audio drivers can correspond to the audio driver 10 described above. The audio drivers of the audio driver array can differ in size and shape, depending on the embodiment. It is intended that the audio drivers can be directly mounted to one another in some embodiments. In these embodiments, their outer frames can have mating features which allow the audio drivers to be directly mounted to one another. For instance, the audio drivers can be directly mounted to one another to form audio driver arrays forming rows and/or columns of audio drivers. Alternately or additionally, the audio drivers can be indirectly mounted to one another via an array frame. In these embodiment, the array frame has spaced-apart transducer apertures in which the audio drivers can be mounted. Depending on the embodiment, the array frame can be an open framework or a closed enclosure. Such arrays are often referred to as a column loudspeaker and their historical focus has been in the field of speech reproduction. As these arrays have gotten better, they can be used for music as well as speech. Having the audio drivers mounted into a closed enclosure is useful for developing low frequencies to support the “speech range” performance of the audio driver array in mid-range. For instance, having holes within the magnet assemblies can help the diaphragms excite vibration modes of the enclosure as well.

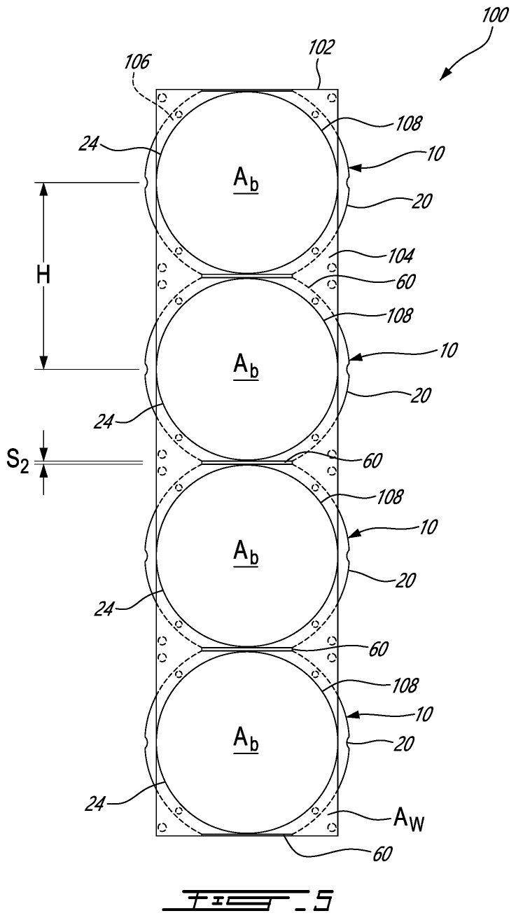

In some other embodiments, the array frame can be provided in the form of a closed housing, such as shown in the example of FIG. 5. This figure shows an example of an audio driver array 100, in accordance with an embodiment. As shown, the audio driver array 100 has a housing 102 having a front wall 104 and a cavity 106 inside the housing 102. The front wall 104 has a number of spaced-apart transducer apertures 108 exposing the cavity 106. In this example, audio drivers 10 similar to the audio driver 10 are mounted to corresponding ones of the transducer apertures 108. Although the transducer apertures 108 are vertically positioned in this example, to provide a column loudspeaker arrangement, the transducer apertures 108 can be positioned in any other suitable manner around the housing 102. In this embodiment, the frames 20 of the audio drivers 10 are sized and shaped so as to abut against one another in a way that is as space efficient as possible. In this way, having audio drivers 10 being closer to one another can increase the coherence with which the sound waves are propagated towards a listener. For instance, the frames 20 have thinner flanged portions 60 at frame abutment locations. Due to the thin annular clearance extending between the wall portion of the frame and the free peripheral edge of the diaphragm, each audio driver can have a smaller footprint. Moreover, the proportion of the radiating surface versus the non-radiating surface can be increased in a way that allows to stack more audio drivers per housing surface area unit, and/or smaller housings for a similar amount of radiating surface. For instance, in the illustrated embodiment, the diaphragms 24 of the audio drivers 10 collectively form a radiating surface area (encompassing the four blackened areas Ab) which encompasses at least 65%, preferably at least 70% and most preferably at least 75% of a surface area Aw of the given wall 104. If one were to calculate similar figures for existing audio drivers having surrounds, the radiating surface areas of the existing audio drivers could encompass no more than about 60% of a surface area of the given wall, due to the non-radiating surface occupied by the surrounds.

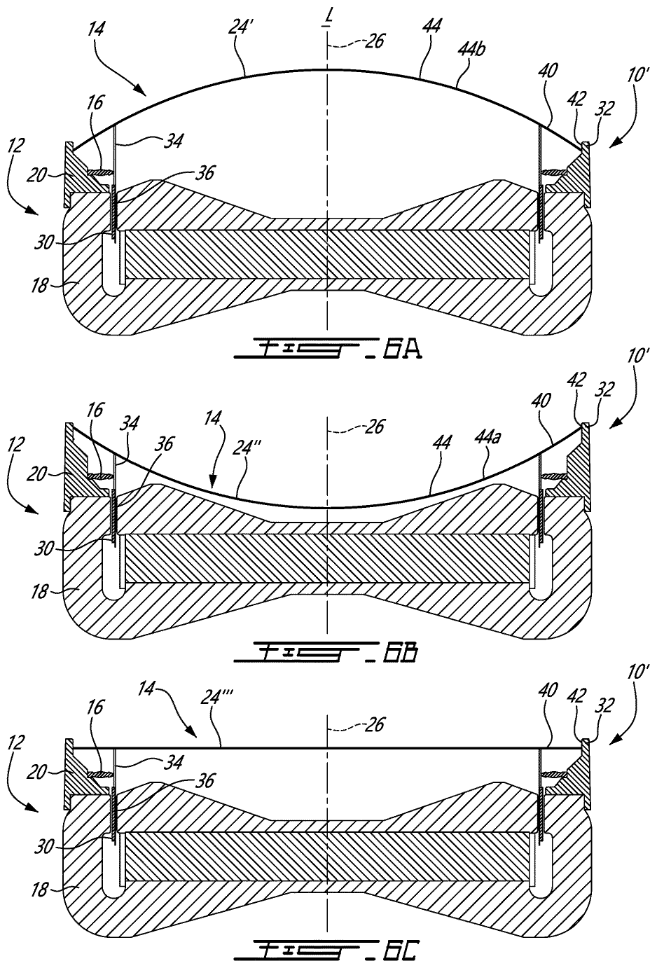

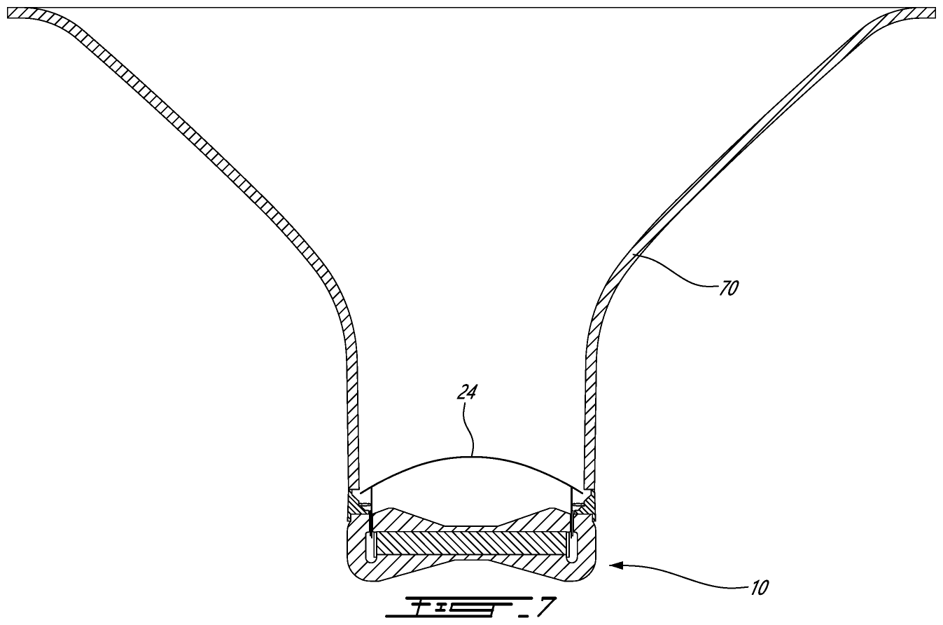

FIGS. 6A, 6B and 6C show different examples of transducers 10′, according to some other embodiments. As depicted, the transducers 10′ each have a static structure 12 having a magnetic gap 30 surrounding the displacement axis 26, and a wall portion 32 extending parallel to the displacement axis 26, facing the displacement axis 26. The transducers 10′ each have a dynamic structure 14 having a coil body 34 surrounding the displacement axis 26, a coil 36 wrapped around the coil body 34, the coil body 34 received in the magnetic gap 30, and a diaphragm 24 extending outwardly from the displacement axis 26 and secured to the coil body 34. In these embodiments, diaphragms 24′, 24″ and 24″ each have a peripheral edge 42 adjacent the wall portion 32, the peripheral edge 42 being unattached to the wall portion 32. As shown, the transducers 10′ each have a suspension 16 connecting the static structure 12 to the dynamic structure 14.

Referring now specifically to FIG. 6A, the diaphragm 24′ has a spherical cap 44 with a convex face 44b facing the listener L, away from the static structure 12. In this embodiment, a peripheral portion 40 of the diaphragm 24 is also part of the spherical cap 44, as it extends both radially outwardly from the body 34 and obliquely towards the static structure 12 in a way that convexity is continuous up to the edge 42. The opposite is also a possible embodiment, such as shown in FIG. 6B. In this embodiment, the diaphragm 24″ has a spherical cap 44 with a concave face 44a facing the listener L, away from the static structure 12. In this embodiment, the peripheral portion 40 is also part of the spherical cap 44, as it extends both radially outwardly from the body 34 and obliquely away from the static structure 12 in a way that concavity is continuous up to the edge 42. In FIG. 6C, the diaphragm 24″′ is neither convex nor concave but planar, which can be convenient in at least some applications. In these embodiments, the frames 20 are sized and shape to provide suitable positioning of the wall portion 32. In other words, regardless of the axial position of the edge 42 relative to the static structure 12, the frame 20 is constructed such that the wall portion 32 is closer or farther away from the static structure 12 so as to allow frictionless oscillation of the edge 42 adjacent the wall portion 32.

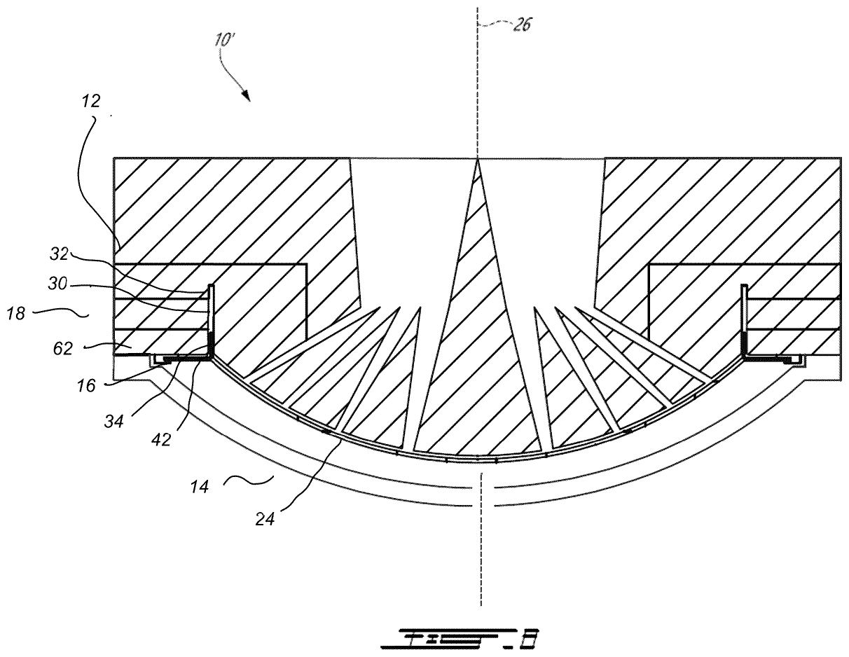

In some embodiment, the audio driver 10 is loaded with a horn 70 such as shown in FIG. 7. In these embodiments, the diaphragm 24 remains harmonics-free when operated under additional pressure exerted by the horn 70. This is in contrast with conventional horn-loaded audio drivers which surrounds can damage as per the additional pressure exerted by the horn. As such, existing audio drivers placed in a horn-loaded application can have added deflection of the surround itself due to the increased pressure at the face of the diaphragm. This sound deflection introduces harmonics not found when the existing audio driver operates in a direct radiator configuration, which can create enough stress on the surround to create fractures or other types of damage to it. At least some of these inconveniences can be alleviated by using the audio driver of FIG. 7.

FIG. 8 shows an example of a transducer 10′, in accordance with another embodiment. In this example, the transducer 10′ has a static structure 12 having a magnetic gap 30 surrounding a displacement axis 26, and a wall portion 32 extending parallel to the displacement axis 26, facing the displacement axis 26. The transducer 10′ has a dynamic structure 14 having a coil body 34 surrounding the displacement axis 26, a coil 36 wrapped around the coil body 34, the coil body 34 received in the magnetic gap 30, and a diaphragm 24 extending outwardly from the displacement axis 26 and secured to the coil body 34, the diaphragm 24 having a peripheral edge 42 adjacent the wall portion 32, the peripheral edge 42 unattached to the wall portion 32. In this specific embodiment, the diaphragm 24 is shown without a peripheral portion protruding outwardly away from the coil body 34. Rather, the peripheral edge 42 is joined to the coil body in a manner which allows a frictionless pistonic motion of the peripheral edge 42 adjacent the wall portion 32. In this specific embodiment, the peripheral edge 42 forms a corner portion with the coil body 34. As can be understood, in this specific example, the peripheral edge 42 is not free but instead secured to a portion of the coil body 34. It was found that such configuration can be satisfactory for audio drivers in the high frequency range, i.e., for tweeter systems, in at least some applications. The transducer 10′ also has a suspension 16 connecting the static structure 12 to the dynamic structure 14. The suspension is not limited to a connection between an outer frame of the transducer 10′ and the coil body 34, and can also be provided inwardly of the coil body 34. As depicted, the suspension 16 can connect the coil body 34 to a pole piece 62 of the magnet assembly 18 of the static structure 12. It is understood that the suspension 16 can be a first suspension member, and that the transducer 10′ can include other suspension members, such as a second suspension member, as long as the suspension members are not connecting the wall portion 32 to the peripheral edge 42. The first suspension member connects an interior surface of the coil body 34 to the pole piece 62 in a way that the first suspension member extends radially outwardly between the coil body 34 and the static structure 12 relative to the displacement axis 26. In some embodiments, a second suspension member can connect a frame 20 of the static structure 12 to an exterior surface of the coil body 34 in a way that the second suspension member extends radially inwardly between the coil body 34 and a pole piece of the static structure 12. As such, the suspensions can extend either radially or axially depending on the embodiment. Other suspensions or suspension types can be included in other embodiments.

As can be understood, the examples described above and illustrated are intended to be exemplary only. For instance, although the audio driver can be used in audio applications such as those described above, and other audio applications, the transducers described herein can be used as well for non-audio applications or applications generating longitudinal pressure waves having a frequency outside the acoustic frequency range. The diaphragm can be provided with any suitable shape including, but not limited to, conical, curvilinear conical, a spherical, domical or perhaps a rotational dome derived from arbitrary arcs. Although the cylindrical and annular shapes have circular cross-sections, it is understood that the cylindrical and annular shapes described herein are meant to encompass circular and oval cross-sections. The scope is indicated by the appended claims.

1. A transducer having a displacement axis and a transverse plane transverse to the displacement-axis, comprising:
a static structure having a magnetic gap surrounding the displacement axis, and a wall portion extending parallel to the displacement axis, facing the displacement axis;
a dynamic structure having a coil body surrounding the displacement axis, a coil wrapped around the coil body, the coil body received in the magnetic gap, a diaphragm extending outwardly in a plane parallel to the transverse axis from the displacement axis and secured to the coil body, the diaphragm having a peripheral edge adjacent the wall portion, the peripheral edge unattached to the wall portion; and
a suspension connecting the static structure to the dynamic structure, the suspension permitting movement of the dynamic structure axially along the displacement axis and limiting movement of the dynamic structure along the transverse axis, the suspension biasing the dynamic structure to a rest position, thereby delimiting a movement span xₘₐₓ of the peripheral edge, the movement span xₘₐₓ defined axially, parallel the displacement axis, between an xₚₗᵤₛ position and xₘᵢₙᵤₛ position, the wall portion spanning the movement span xₘₐₓ of the peripheral edge.

2. The transducer of claim 1 wherein the diaphragm has a peripheral portion protruding from the coil body in a direction away from the displacement axis, the peripheral edge being a free peripheral edge.

3. The transducer of claim 2 wherein the diaphragm has a spherical cap concentric the displacement axis, the peripheral portion extending around the spherical cap, the spherical cap having a concave face opposite a convex face, one of the convex face and the concave face facing away from the static structure.

4. The transducer of claim 3 wherein the peripheral portion has a truncated conical shape surrounding the displacement axis, the truncated conical shape being sloped obliquely relative the displacement axis.

5. The transducer of claim 3 wherein the peripheral portion is part of the spherical cap.

6. The transducer of claim 2 wherein the diaphragm has a central portion surrounded by the peripheral portion, the central portion spanning a first cross-sectional area, defined relative the displacement axis, the peripheral portion spanning a second cross-sectional area, the first cross-sectional area greater than the second cross-sectional area.

7. The transducer of claim 1 wherein the wall portion circumscribes a first cross-sectional area defined relative the displacement axis, and the diaphragm spans a second cross-sectional area, the second cross-sectional area covering at least 95% of the first cross-sectional area, preferably at least 97%.

8. The transducer of claim 1 wherein the suspension comprises a first suspension member extending radially outwardly between the coil body and the static structure relative the displacement axis.

9. The transducer of claim 1 wherein the wall portion is cylindrical and the peripheral edge is circular.

10. The transducer of claim 1 further comprising a clearance defined radially between the peripheral edge and the wall portion, the clearance being less than 500 μm.

11. The transducer of claim 9 wherein the static structure has an annular resonant cavity opened at a clearance defined radially between the peripheral edge and the wall portion, the annular resonant cavity having a Helmholtz frequency tuned above a passband of the transducer.

12. The transducer of claim 1 wherein the diaphragm is made of a composite material.

13. The transducer of claim 1 wherein the diaphragm is made of titanium.

14. The transducer of claim 1 wherein the diaphragm is made of a plastic.

15. The transducer of claim 1 further comprising a horn loaded on the transducer, the diaphragm remaining harmonics-free when operated under additional pressure exerted by the horn.

16. An audio driver array comprising: a plurality of transducers mounted to one another, the plurality of transducers corresponding to the transducer of claim 1.

17. The audio driver array of claim 16 further comprising an array frame having a plurality of spaced-apart transducer apertures, the plurality of transducers mounted to corresponding ones of the plurality of transducer apertures.

18. The audio driver array of claim 17 wherein the array frame is a housing having a wall and a cavity inside the housing, the wall including the plurality of transducer apertures which expose the cavity.

19. The audio driver array of claim 18 wherein diaphragms of the plurality of transducers collectively form a radiating surface area, the radiating surface area encompassing at least 65% of a surface area of the wall.

20. A method of driving an audio driver comprising a static structure having a wall portion and a dynamic structure having a displacement axis and comprising a coil body and a diaphragm extending transversely from the displacement axis, the method comprising:
circulating an audio signal in the form of an electrical current along a coil wrapped around the coil body, thereby generating an electromagnetic field; and
the electromagnetic field engaging a magnetic field in a magnetic gap, thereby moving the diaphragm including moving a peripheral edge of the diaphragm reciprocally within a movement span, parallel to the displacement axis, the peripheral edge remaining adjacent to, surrounded by, and unattached to the wall portion of the static structure throughout said movement span.
